(19) United States
(12) Patent Application Publication
(10) Pub. No.: US 2007/0073605 A1
(43) Pub. Date: Mar. 29, 2007

(54) System and method for trading options in the marketplace

(75) Inventors: Itai Kohavi, Hod-Hasharon (IL); Yoah Bar-David, Kfar Hes (IL)

Correspondence Address: BROWDY AND NEIMARK, P.L.L.C.;624 NINTH STREET, NW, SUITE 300, WASHINGTON, DC, 20001-5303, US

(73) Assignee: Via Option Ltd., Hod Hasharon (IL)

(21) Appl. No.: 11/235,535

(22) Filed: Sep. 27, 2005

(51) Int. Cl. G06Q 40/00

(52) U.S. Cl. 705/37

(57) ABSTRACT

A method for trading non financial options in a virtual marketplace, including an option seller that provides for trading an option in respect of product or service. The option is associated with option price and option terms including option expiration date. An option buyer provides a buying price. There is further provided the step of calculating option trading, including transferring option ownership to the buyer if the following conditions are met: (i) verifying at least the seller, the buyer and the option, (ii) determining that if the option price matches said buying price, and charging the buyer with an option price.

### FIELD OF THE INVENTION

This invention relates to a system and method for trading options in the marketplace.

### BACKGROUND OF THE INVENTION

In today's market, there is a mechanism for issuing and trading options on financial products, mainly on stocks and currency exchange rates.

For other types of products, sometimes there are ways to purchase option-like products. A few examples:

One can buy a cancelable airline ticket, where if one cancels the ticket within a predefined time, one gets some of the money back (not all of it). The money that one loses when canceling is equivalent to an option price. Cancellation fees are in fact an option: the buyer buys some product that he knows he can cancel later and pay cancellation fees. In a sense the buyer buys an option for the product which costs the amount of the cancellation fees, and the product is purchased for the difference between the quoted price and the cancellation fee.

Some real estate agents ask that the buyer pay upfront a certain amount of money, before the sell is finalized, to guarantee the property and price.

Other industries do not provide options or options-like products. For example a customer cannot typically buy an option on a computer, a new car, a hotel room, and many other types of products.

The value of options to buyers is that they can make the buy/no-buy decision in a two step form, instead of making a single decision to buy (a big leap), the buyer can pay a relatively small amount of money, buy the option (a small step), just to guarantee that he/she can make the buy/no-buy decision without the risk of the product going out of stock, or the price changing, within a given amount of time. A few exemplary reasons why buyers will prefer to buy options if they could are:
They need to consult with others (e.g. a person buying a used car for his wife wants to show her the car before buying it, but does not want anyone else to buy the car before his wife sees it)
They want to explore other products (e.g. go to other car dealers and see other cars, but do not want anyone else to buy this car because it appears to be a good car)
They want to collect more information before making the buy/no-buy decision (e.g. a sports fan wants to hold tickets to the finals game, but actually only wants to go if his team makes it to the finals)

Sellers recognize the options value to buyers, and have used some methods similar to options. Many sellers guarantee that a buyer can return the product within a limited time duration, and get full refund. This is an option with a zero price. While this method is convenient to consumers, it has drawbacks to sellers. It makes it too easy for consumers to cancel, and has associated cost for the seller.

Some sellers allow only partial refunds (which is similar to an option). Some sellers do not refund real money but rather refund credit to purchase in the same shop.

The value of options to sellers are, for example:
Easier to get buyers committed to buy (“smaller” decision for buyers, and when buyers pay something, they will more likely buy the product)
An additional revenue stream from customers who will buy the option but will not exercise the option.
Ability to sell more options than products (for example, when selling a sports event ticket, one person can buy an option for a ticket only if team A gets to the finals, and another person can buy an option for the same seat if team B gets to the finals, when both teams compete in the semi-finals, and only one team of the two can reach the finals),

Accordingly, there is a need in the art for a standard and across-the-board technique or solution to sell options for products to buyers.

There is a further need in the art to enable a person who purchased an option to find and sell this option to another person who is interested in the specified option.

There is a further need in the art to notify the original product seller when options are traded, for example, if the product is a hotel room reservation (an option to use a hotel room at a given date), the hotel needs to have in its reservation system the name of the new option owner.

### SUMMARY OF THE INVENTION

The present invention provides a method for trading non financial options in a virtual marketplace, comprising: an option seller provides for trading an option in respect of product or service; the option is associated with at least option price and option terms including option expiration date; an option buyer provides at least a buying price; calculating option trading, including transferring option ownership to the buyer if at least the following conditions are met: verifying at least the seller, the buyer and the option, determining that if the option price matches said buying price; charging the buyer with an option price.

The present invention further provides a method for trading options in a virtual marketplace, comprising: an option seller providing an option for trading; the option is associated with at least option price and option terms including option expiration date; calculating trust guarantee associated with said option.

Further provided by the present invention a method for trading non financial options in a virtual marketplace, comprising: a seller providing a product or service for sale; providing an option associated with the product or service for trading; trading the option and notifying the seller of the product that the associated option was traded.

It is yet further provided by the present invention a program storage device readable by machine, tangibly embodying a program of instructions executable by the machine to perform method steps for trading non financial options in a virtual marketplace, comprising: providing for trading an option in respect of product or service; the option is associated with at least option price and option terms including option expiration date; providing at least a buying price; calculating option trading, including transferring option ownership to the buyer if at least the following conditions are met: verifying at least the seller, the buyer and the option, determining that if the option price matches said buying price; charging the buyer with an option price.

Further provided by the present invention a system for trading non financial options in a virtual marketplace, comprising: a unit configured to provide for trading an option in respect of product or service; the option is associated with at least option price and option terms including option expiration date; a unit configured to provide at least a buying price; a unit configured to calculate option trading, including transferring option ownership to the buyer if at least the following conditions are met: verifying at least the seller, the buyer and the option, determining that if the option price matches said buying price; charging the buyer with an option price.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates general system architecture, in accordance with an embodiment of the invention;

FIG. 2 illustrates a flow diagram of a sequence of option trading operation, in accordance with an embodiment of the invention;

FIG. 3 illustrates a flow diagram of a sequence of option cancellation operation, in accordance with an embodiment of the invention.

### DETAILED DESCRIPTION OF EXEMPLARY EMBODIMENTS

For a better understanding of various embodiments of the invention, there follows a list of definitions, some are known and others have been coined. Note that the definitions are provided for clarity only and are by no means binding:

Seller: In a certain embodiment, a person or organization that sells or wants to sell an option (in respect of a product(s) or service(s)) to another person or organization (the buyer)

Buyer: In a certain embodiment, a person or organization that buys or wants to purchase an option (in respect of a product(s) or service(s)) from another person or organization (the seller)

Transaction: In a certain embodiment, an event in which a seller and buyer exchange a product or service for an agreed amount of money (the price).

Product/service: In a certain embodiment, product(s) or service(s) that are owned by the seller and are being sold to the buyer in the transaction.

Option: In a certain embodiment, a tool that indicates a guarantee and commitment of the seller to sell the buyer a specified product or service at a specified price with specified terms. For example an option can be a seller guaranteeing that he/she will sell the buyer a specific car for a specific price within a specific time duration, if the buyer chooses to buy the car. Note that financial options are options traded in a regulated financial exchange (e.g. stock exchange or derivatives exchange).

Option Price: In a certain embodiment, the price (in cash and/or other tradable asset of monetary value) that is asked by the buyer to guarantee the option to the seller. This should not be confused with the product price. (Example: A car dealer tells potential buyer who is interested in a specific car, that he, the dealer, will keep this specific car and not sell it to anyone else for a week, and the buyer can come anytime during this week and buy the car for $10,000 (product price). The car dealer asks for $200 (option price) to be paid for keeping the car and guaranteeing the price to the buyer).

In finance, an option is a contract whereby the contract buyer has a right to exercise a feature of the contract (the option) at a future date (the exercise date), and the ‘writer’ (seller) has the obligation to honor the specified feature of the contract. Since the option gives the buyer a right and the seller an obligation, the buyer has received something of value. The amount the buyer pays the seller for the option is called the option premium.

Option trading: In a certain embodiment, an event in which a seller sells a buyer an option, typically in exchange for option price and possibly other terms. Option trading includes an initial option trading between a product (service) provider and a buyer and subsequent option trading (also referred to as option transfer) between a buyer (of a previously traded option) and a new buyer. The terms of the options may allow or restrict option transfer.

Option Exercise: In a certain embodiment, an event in which an option owner implements the rights of an option, by buying the underlying product.

Option Cancellation: In a certain embodiment, an event in which the buyer notifies the seller that he/she is no longer interested in exercising the option. After cancellation, the seller is no longer committed to provide the buyer the given product/service of the option. At cancellation there may or may not be an option cancellation fee or refund, depending e.g. on the option terms. In the financial options market, options do not get cancelled, just exercised or expired. For non-financial options, there may be a value for the cancel operation, where the seller can earlier release inventory allocated for the option.

Option Expiration: In a certain embodiment, an event in which the terms of the option become void, and the option is considered as cancelled, possibly without a need of the buyer to explicitly notify the seller.

Option Expiration Date: In a certain embodiment, the date on which an option expires, and becomes worthless if not exercised.

Option Terms: In a certain embodiment, at least one of the following: the details, specifications, obligations, requirements, and conditions of the Option Contract. For instance, a condition may prescribe the time in which the option can be exercised (e.g. certain period of time: “3 days”). In accordance with another example, terms can also define Option Transfer conditions, cancellation conditions, and exercise conditions (see below) etc. For a better understanding there follows a non-limiting example of option terms:

General Conditions

Expiration time
   Transfer conditions
Is the option transferable
When may the transfer occur (may be different to expiration time)
Restrictions on new buyers: number of people (e.g. for hotel room), age (e.g. for rental cars), geographic restrictions (e.g. can be transferred only to US citizens or residents), attribute restrictions (e.g. can be transferred only to credit card owners, or valid passport holders)
Fees: What is the fee (if there is a fee) for the transfer
   Exercise conditions
Payment conditions: for example the seller will accept only cash for the exercise, payment currencies,
   Shipment conditions: destinations that are or are not supported
   Cancellation conditions
Can the option be cancelled
Payment: If and what is the refund for cancellation

Option Provider: In a certain embodiment, the original seller of the option. This is the person or organization which directly or indirectly will provide the underlying product/service in case of option exercise.

Option Owner: In a certain embodiment, the most recent buyer of the option.

The definitions above are provided for illustrative purposes only, and in respect of some of the terms there are other known per se sources which provide definitions and examples.

Unless specifically stated otherwise, as apparent from the following discussions, it is appreciated that throughout the specification discussions utilizing terms such as, “processing”, “computing”, “calculating”, “determining”, “verifying”, “performing” or the like, refer to the action and/or processes of a computer or computing system, or processor, or similar electronic and/or optical computing device, that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, processor, computer, apparatus, system, sub-system, module, unit, device, site (in single or plural form) for performing the operations herein. This may be specially constructed for the desired purposes, or it may comprise a general purpose computer selectively activated or reconfigured by a computer program stored in the computer. Such a computer program may be stored in a computer readable storage medium, such as, but not limited to, any type of disk including, optical disks, CD-ROMs, flash memory (e.g. Disk-on-Key), smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes/devices (or counterpart terms specified above) and displays. presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The term database/storage is not bound to any specific realization.

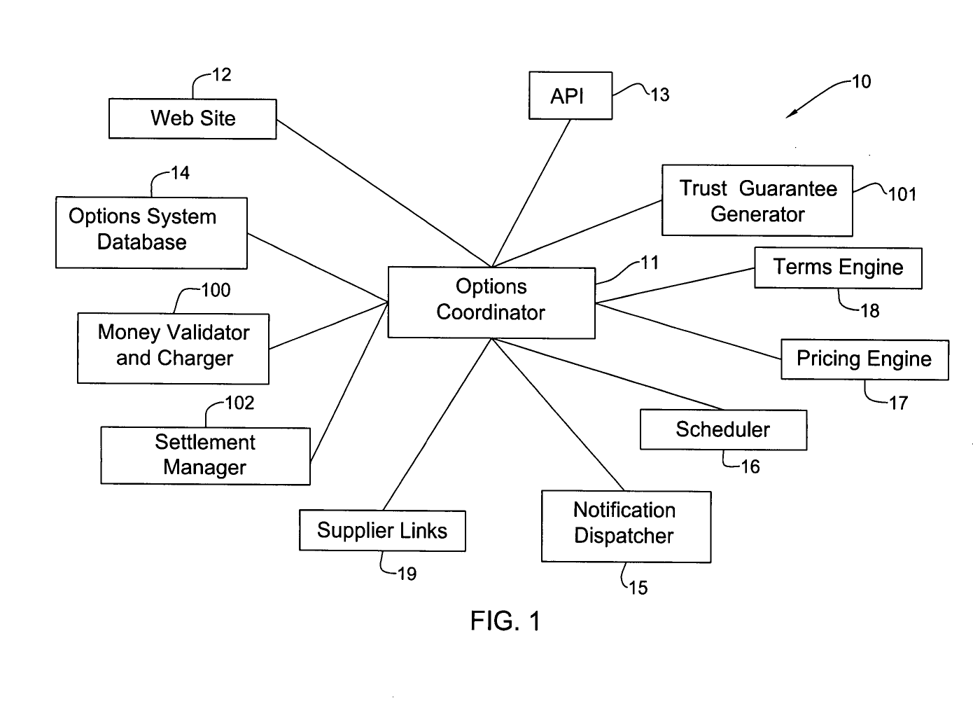

Bearing this in mind, attention is drawn to FIG. 1, illustrating a general system architecture, in accordance with an embodiment of the invention.

As shown, the system 10 includes an Options Coordinator 11, serving as the main module. It is configured to process all option related events and processes (e.g. search, buy, cancel, expire, etc.)

Further shown in FIG. 1, is an Internet web site 12, configured to allow all interactions from a browser-based user interface. The web site is used by sellers for instance to load new options, manage their existing options, see reports, define pricing rules and track money. Consumers (such as sellers and buyers) can access the web site to activate various functions, such as search, buy option, publish their options for sale on this web site, etc.

Further shown in FIG. 1, is an API (13), an application programming interface which facilitates external services and systems (not shown) to access the options system functionality without the web site. It may provide the same functionality as web site access but using external application(s). For instance, the specified application can load new options, cancel options, etc. through the specified API. By way of another non-limiting example, if a seller wants to publish on its own web site options for its own products, then it is possible to access the options database (through secured API functions) to find which options are available, and at which price and terms.

Also shown in FIG. 1, is an Options System Database 14 which facilitates storage of information on all options and their characteristics. The data in respect of the options is utilized for various types of option processing, as will be discussed in greater detail below.

Still further, Notification Dispatcher 15 is configured to process messages including sending messages to consumers on events that require a notification. A notification can be an email message, fax, phone, SMS, application-messages and more.

Scheduler 16 is a module that is configured to process time related tasks, such as checking constantly which options need to be expired, or initiating periodical reports. The scheduler initiates, for example, the automatic option generation process, which is explained in greater detail below.

Pricing Engine 17 is a module that is configured to compute option prices. Option prices can be loaded manually, but can also be fully or partially automatically computed, e.g. based on rules defined by the option provider.

Terms Engine 18: is a module that is configured to compute option terms. Option terms can be loaded manually, but can also be fully or partially automatically computed, e.g. based on rules defined by the option provider.

Supplier Link 19: is a module that is configured to maintain a link between the options system to the option underlying product provider's database, web site or computer programs. Messages can be sent through the supplier link to the provider when an option event occurs, or receive a request from the provider's system. (Note that the provider is referred to as a supplier).

Money Validator and Charger 100: a module that is configured to process charging actions. It is configured to process fraud screening, actual charging depending on the payment method (e.g. credit card, PayPal), all as known per se.

Trust Guarantee generator module 101 is configured to process (including generation) of system option trust guarantee, as will be explained in greater detail, below.

The Settlement Manager 102 is responsible to manage all the financial related settlement processes between the system and its users. It generates payment reports and files to various users and systems, so that each user or company receives the due money at the due time. This module is generally known per se and therefore will not be further expounded upon herein.

Note that the architecture of FIG. 1 is by no means binding. In accordance with certain other embodiments one or more of the modules may be deleted and/or modified and/or others may be added. By way of non limiting example, in accordance with a certain embodiment, the API module may be deleted. In accordance with a certain embodiment, some of the specified modules may be consolidated, e.g. pricing engine and terms engine. In accordance with a certain embodiment, some of the functionalities of the specified modules may be modified.

Before turning to describe a specific sequence of operations, in accordance with a c ertain embodiment of the invention, it should be noted that in accordance with a certain embodiment of the invention, there is provided an unregulated virtual marketplace (e.g. through the web) where options can be issued by individuals or organizations, and sold to individuals or organizations. Note that unlike stock exchange, in un-regulated marketplace the prospects of encountering fraud options and/or untrusted sellers as well as buyers are considerably higher, and therefore the need to validate parts or all of the trading related data (e.g. the seller the buyer and the option) and provide trust, arises.

In accordance with a certain embodiment, a system stores information at various stages of the options life-cycle, and makes part of this information available to buyers and sellers, in a way that validates at least the seller, buyer and the option in the options trading process.

In accordance with a certain embodiment, for option providers (sellers) the system records feedback from buyers (e.g. as in eBay).

In accordance with a certain embodiment, trading of options in the virtual marketplace includes issuance of option. The issuance of options may involve trust guarantee of options in accordance with various criteria, as will be explained in greater detail below. For instance, trust guarantee can be based on historic performance, and on/or business contracts, deposits and insurance plans with the specific option provider (agreements between the option provider and the system). For example, the system's staff will perform business analysis on a new car dealer, and using various financial methods (e.g. escrow deposited money, insurance plan), will provide the car dealer with a certificate of trust, which will be displayed to all option buyers that look at options of that specific seller. In accordance with a certain embodiment, the system can provide guarantees to buyers backed by financial guarantee commitments (a type of insurance, limited risk, risk sharing etc)

The trading of options may include selling an option from the product provider. In accordance with a certain embodiment, the system (e.g. the option coordinator 11 using the option system database 14) verifies the identity of the seller and buyer, and selected option details. The system records all the sale information in database 14 (attached to the issued option details). The system records (in the database 14) the option underlying product, price and terms, the buyer information. The system may perform the actual payment transfer to verify that all conditions for ownership transfer have been met. As will be explained in greater detail below, in accordance with a certain embodiment, the option price and/or terms (or portion thereof) can be determined automatically using, for instance, Pricing engine 17 and Terms engine 18.

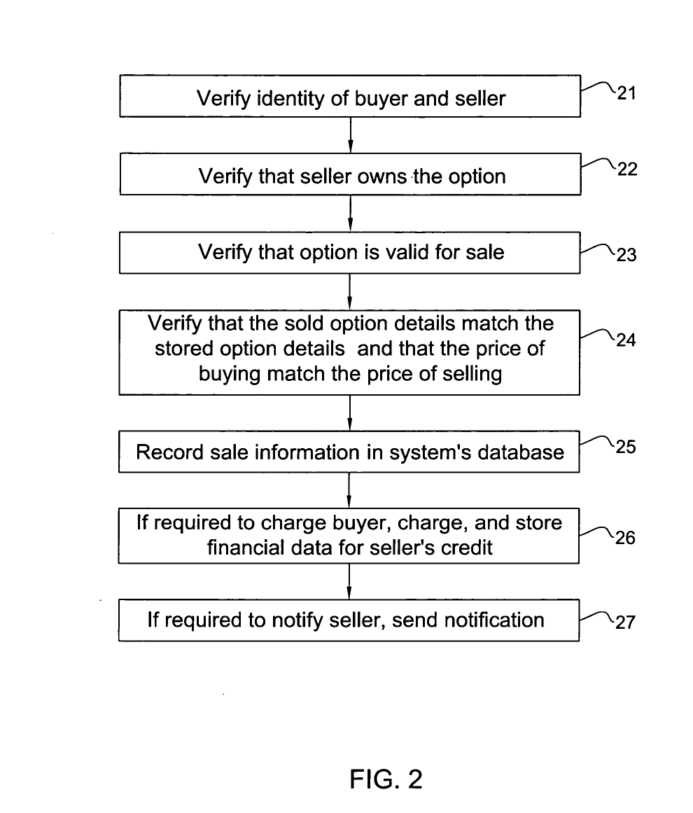

Thus, in accordance with a certain embodiment (with reference to FIG. 2) selling an option from a product provider, includes the following processing:
1. Verify identity of buyer and seller 21
2. Verify that seller owns the option 22
3. Verify that option is valid for sale 23
4. Verify that the sold option details match the stored option details. Note that when an option is sold, it had to exist already and was stored in the database. In addition, determine that the price of buying match the price of selling. 24
5. Record sale information (including transfer of ownership) in system's database 25
6. If required to charge buyer, charge, and store financial data for seller's credit 26
7. If required to notify seller, send notification 27

Note that the invention is not bound by the specified sequence. In accordance with a certain embodiment (with reference also to FIG. 1) stages 21-25 may be implemented using option coordinator 11 and using database 14. Stage 26 may be implemented using also module 100 and stage 27 using also notification dispatcher module 15 or Supplier Links 19.

Note also that in accordance with a certain embodiment, matching prices means identical prices, i.e. the buyer offers to the seller the price requested by the latter. In accordance with a certain embodiment, determining match does not necessarily mean equal prices. Thus, in accordance with a certain embodiment, determining match includes applying known per se bargaining techniques, such as auction, reverse auction etc. Using the specified technique may end in a deal price that is different from the initial selling/buying price quoted by the seller/buyer. Note that the invention is not bound by any specific bargaining technique.

Having bought an option, the buyer can opt to place the option for trading. In accordance with a certain embodiment, the system verifies the identity of the seller (in this case the seller is not the original product provider) and buyer, the option details (or portion thereof), and that the selling person or organization actually owns the specified option. The system also verifies that the option terms are met (say, permit transfer of ownership), and that the expiration date has not been reached, and that all other option terms do not conflict with the transfer of ownership. A simple example can be a term that prescribes that an option is not transferable and accordingly any attempt to trade the option “conflicts” the term and therefore trading will not occur. Another example (where the underlying product is booking of hotel room) is an option term that prescribes that the hotel room is for up to 2 people in a room, and can therefore not be transferred to someone looking for a room for 3 people.

The specified actions may be implemented using Options coordinator and Options database modules (11 and 14). The system may perform the actual payment transfer to verify that all conditions for ownership transfer have been met. In a certain embodiment, the system interacts with the option provider to notify about the ownership transfer and receive an authorization for the ownership transfer using for instance the Supplier Links 19 or Notification Dispatcher 15. All or selected interactions with the seller are recorded by the system.

Thus, in accordance with a certain embodiment, selling an option from a non product provider, includes stages similar to those specified with reference to FIG. 2, except for the fact that at the option transfer event (not the first sell) there is a need to validate the option's transfer terms.

In accordance with a certain embodiment, the trading includes an option cancellation. Thus, in accordance with exemplary cancellation process, the system verifies the option details, and that the person or organization making the change to the option owns the specified option. The system also verifies that the option terms permit the change, that the expiration date has not been reached, and that all other option terms do not conflict with the change. This is realized using e.g. Option coordination module 11 and Option system database 14. In a certain embodiment, the system interacts with the option provider to get additional information or additional authorization for the change performed. All or selected interactions with the seller are recorded by the system in database 14.

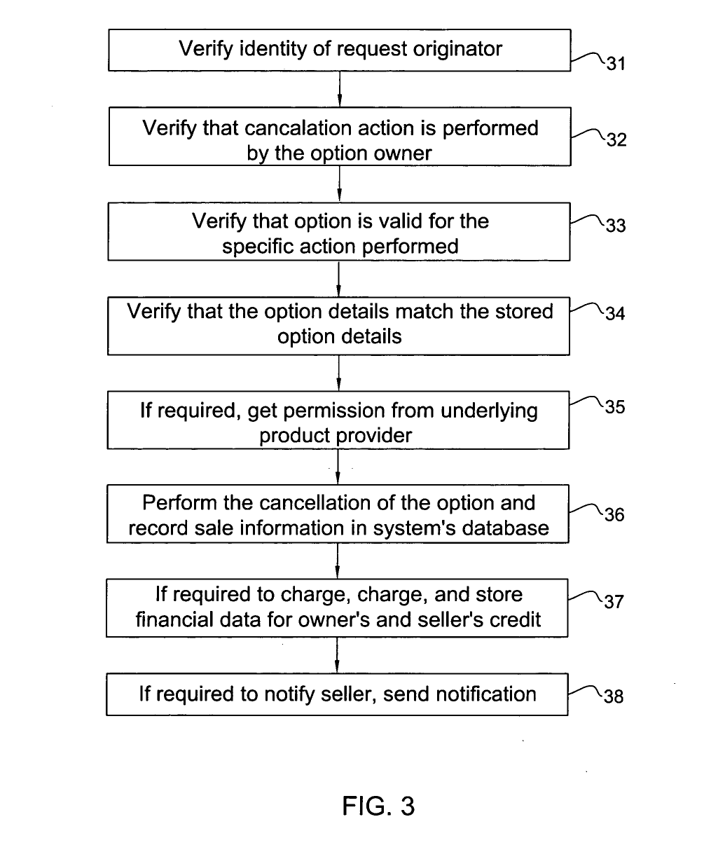

Thus, in accordance with a certain embodiment (with reference to FIG. 3), canceling an option, includes the following processing:
1. Verify identity of request originator 31
2. Verify that specific cancellation action is performed by the option owner 32
3. Verify that option is valid for the specific action performed 33
4. Verify that the option details match the stored option details 34
5. If required, get permission from underlying product provider 35
6. perform the cancellation of the option and record sale information in system's database 36
7. If required to charge or refund, perform the action and store financial data for owner's and seller's credit 37
8. If required to notify seller, send notification 38.

Note that the invention is not bound by the specified sequence. In accordance with a certain embodiment (with reference also to FIG. 1) stages 31-36 may be implemented using option coordinator 11 and using database 14. Stage 37 may be implemented using also module 100 and stage 38 using also notification dispatcher module 15 or Supplier Links 19.

In accordance with a certain embodiment, when an option is exercised, the system verifies the option details, and that the person or organization making the exercise owns the specified option. Using the system the seller is able to verify the identity of the option owner before providing the underlying product.

The invention is likewise not bound to the specified sequence.

In accordance with a certain embodiment, the verification sequence described above (for instance for selling, cancellation and exercise of option may include the following processing:
1. Verify identity of buyer and seller, e.g. by password check, by a code generation device, by a biometric check or any other commonly used method to authenticate a user.
2. Verify that seller owns the option
   Done by a database check to match that the option number is indeed owned by the user ID of the seller
3. Verify that option is valid for sale/transfer/exercise
   According to the requested operation (sale/transfer/exercise), the system checks that the option terms allow the specific operation at the specific time and for the specific buyer. Examples can be checking that the option is not expired (in the option terms), checking that the option is transferable (in the option terms) or that the buyer's request matches the option details (for example an option on a hotel room for 2 people can not be sold or transferred to someone looking for a room for 3 people).
4. Verify that the sold option details match the stored option details.
   In cases where the option details are displayed by the system (e.g. on the system's web site), this step may not be required. In cases where the option information was displayed somewhere else (e.g. on the seller's web site), this step will verify that the information displayed to the buyer matches the system's information. The operation is performed by comparing the system database records of the option to the information displayed, or alternatively by displaying the system's information and letting the buyer do the comparison.
5. If required, get permission from the underlying product provider.
   This is done by sending a message to the seller's inventory management system with the requested operation and option details (using Supplier Links 19), and receiving from the seller's system a confirmation reply (or reject reply) for the operation. The sent message and the reply are recorded in the system's database 14.
1. Record sale information in system's database 14.
   Make the required changed in the system's database to reflect the change of ownership, and the financial implications of the transactions (e.g. increase credit of seller). This step occurs only after all the previous validation steps have been successful.
6. Charge buyer.
   By using various financial methods, charge the seller for the amount of the transaction. Payment methods may be credit-card, PayPal, or other commonly used methods. Performed by the Money Validator and Charger 100.
7. Notify seller.
   Optionally, send a message to the seller's inventory management system (using Supplier Links 19) to notify the completion of the operation.

The invention is by no means bound by the specified verification steps, their contents and/or their order.

As specified before, in accordance with a certain embodiment, there is provided an automatic technique for generating option prices and/or option terms. Thus, for example, the system is connected (possibly remotely, using conventional means) to the supplier's inventory system (say through supplier link 19 of FIG. 1), and using defined rules and logic, automatically creates options from existing products. For example, rules can decide on which products options are generated, option pricing, option expiration dates, and other option terms.

In most inventory systems, the seller has a system that contains a list of products, and for each product contains its price and inventory. In accordance with a certain embodiment, the options generator (composed by-the non limiting example of FIG. 1 of terms engine 18 and pricing engine 17) scans the inventory database, historic sales data, and defined rules, and generates options, or modifies existing options, according to the defined rules and logic. The options generation process can be done periodically (e.g. using scheduler 16) on the entire database or a subset of the entire database. This is further exemplified below when rules are used.

In accordance with a certain embodiment, the options generation can also be invoked when a user is searching for a specific product in the remote supplier's site (not shown in FIG. 1) using the API 13. More specifically, the option generation can occur for a limited set of products while the user is performing the search. The system receives an options search request (from the web site 12 or from the API 13), translates it to product(s) search in the remote suppliers system or database (not shown in FIG. 1). The search commands are invoked through the supplier link 19. Using the product data returned by the supplier's system, and using defined rules and logic, the system automatically creates options (by the Pricing Engine 17 and Terms engine 18). Note that the search module is generally known per se and therefore not expounded upon herein.

In accordance with a certain embodiment, when building options dynamically during search, the system can generate options or price options based on specific characteristic including of the user performing the search. For example, in some industries (such as hotel industry), the inventory systems are dynamic. Thus, price for a room can depend on user or search request details, such as the specific. dates, on the number of nights, on the day of arrival or departure and on various other factors. The price for a specific request is computed dynamically per request. During search, the options generator receives a search request for options for a specific product (e.g. a hotel room), translates this request into one or more requests to shop for hotel rooms in the hotel reservation system (directly or via an intermediate system like a CDS/CRS/Switch, all are known methods to search for hotel rooms), and builds options from the returned products). The price of options is determined by logic and rules defined to the options generator, and possibly also by logic and rules defined in the supplier system, which is triggered by pricing options available in the supplier's reservation system (like rate codes, tour codes, fare basis codes, discount codes, corporate codes).

The automatic generation of option price/option terms is not bound by the specified examples.

The following description explains the rules and logic that are used to process (in this case generate) automatically options, in accordance with a certain embodiment of the invention. The listed rules are provided for illustrative purposes only and are by no means binding.

By this embodiment, the purpose of the rules is to automatically generate options, based on information available in the supplier's inventory system.

Rules determine if an option can be generated for a specific product, and when an option can indeed be generated, the rule defines the option price and terms. Note, incidentally, that in accordance with other embodiments, either one of option price and option terms (or portion thereof) can be generated automatically.

Thus, by this example, the general structure of a rule is:

if <criteria> then <action>

Rules Criterion:

A condition that is required to match information in the inventory system. Examples of criterions:
Current date. e.g. Rule is applicable between Jan. 1, 2006 and Feb. 28, 2006
Product price. e.g. Rule is applicable if product price (as set in inventory system) is at least $500 and not more than $2500.
Inventory level. e.g. Rule is applicable if product has at least 50 more items in stock
Product type and category. e.g. Rule is applicable if product is a computer or an electric kitchen appliance
Product manufacturer. e.g. Rule is applicable for all products made by General Motors
Product date. (applicable for some industries). e.g. Rule is applicable for flights with departure date between Jan. 1, 2006 and Feb. 28, 2006
Product duration. (applicable for some industries). e.g. Rule is applicable for hotel reservations for at least 5 nights
Product additional attributes. Used for unique product attributes for specific industries. For example, for the hotel industry, attributes can be the destination city, the number and ages of the people in the room, the room type, or the floor number.

Rule Criteria

Rules criteria is a combination of rule criterion with boolean operators (AND, OR, NOT).

For example:

Rule is applicable if current date is between Jan. 1, 2006 and Feb. 28, 2006 and product price is more than $350.

Rule Actions:

A rule action can be:
Do not generate an option
Generate an option with specific price and terms. The price and terms are dynamically computed based on product information as stored in the inventory management system.

Example of a rule action:

Create an option with price=5% * product_price, expiration date=current_date +7 days

Example of a Complete Rule:

```
if product price > $500 and items_in_stock < 20
    then create option with price=2%*product_price+
10, expiration date= current_date + 14
if product price < $300
    then do not create option
```

Multiple Matching Rules

When more than one rule matches, there may be a few strategies to choose the desired action. These strategies can be defined by a provider company, per product category, or by other criteria. A few non-limiting possible strategies are:
Select the first rule (order preference)
Select the cheapest (or most expensive) option price (price preference)
Select a rule by an additional preference/rank field defined for each rule (manual preference)
Send an alert and do not generate an option (restrict)

Note that the invention is not bound by using rules for automatically generating options prices and/or terms, and a fortiori by the specified rules criterion, criteria and actions.

As specified above, in accordance with a certain embodiment, the system is configured to generate a trust guarantee. The trust guarantee may be advantages in the case of un-regulated virtual marketplace and confer higher degree of certainty to the buyers, thereby increasing trading volume and credibility of the trading system.

In accordance with a certain embodiment, the trust guarantee is a system trust guarantee (STG) indicative of a measure used to show consumers how “safe” it is to buy a specific option from a specific seller.

In accordance with a certain embodiment, the system stores all the option details: the underlying product, the price and the agreed upon terms in the system database (14 in FIG. 1). These terms can be altered until the option is purchased, but once purchased, the terms can no longer be modified.

In accordance with a certain embodiment, the trust level can be a perception-only (information-only) value. In accordance with a certain embodiment, the trust level may have active implementations, for instance, where a user may be entitled to money back in case of supplier fraud (a form of insurance). In still other embodiments of the invention the STG may be utilized (alone or with additional data) as a criterion whether or not to perform a given action, e.g. blocking trading of options whose STG score drops below a given value. Other actions may be invoked based on the STG score and possibly other factors, or based on other trust guarantee, all as required and appropriate.

Reverting to the STG, in accordance with a certain embodiment, and in order to be easily readable by humans, the STG is computed and displayed as a discreet value within a predefined integer range (e.g. percent 0-100, or 0-5 stars, or rank between A-to-D, etc.).

In accordance with a certain embodiment, the STG rank may indicate insurance full/partial or no coverage.

The insurance (full or partial coverage) can be based on several factors, such as:
System backed (the system takes the risk and provides the funds);
Backed by an insurance with a second tier insurance plan;
Backed by a product provider (i.e. the seller of the option) deposit to the system or to an escrow account;

Other examples are applicable.

Insurance in respect of a specific option can have a limit (covered up to some amount) or be unlimited. Thus, for example, if the seller is an authorized seller, and the option is within the authorization limits (e.g. maximal product price) then the system gives the option a 100% system-trust guarantee. If the seller has a guarantee up to a limited product price, the system generated a partial level of guarantee.

In accordance with a certain embodiment, one or more of the following variables may affect the computation of STG:
The trust level of a specific seller (as will be explained in greater detail below);
The price of the option;
The historic data of sales by the seller;
Feedback of previous buyers from this seller;
   The historic data of sales by the seller can be determined, e.g. by factoring one or more of the following parameters: the number of sales, volume of sales, and number of chargeback and disputes in a recent defined time duration. Other variants are applicable, all as required and appropriate.

In accordance with a certain embodiment, one or more of the following variables may affect the calculation of the trust level of a specific seller:
Agreement between system and supplier
Insurance plan of supplier, type and amount limit
Historic sales data of the supplier: amount of disputed and insurance claims, number and volume of sales that did not have dispute

In accordance with a certain embodiment, the STG is computed as a formula that is based on some or all the above variables. The specific formula used for each seller is configurable. The result of the formula is a value that indicates the STG.

There follows a description that illustrates in a non limiting manner sequence of operation for calculating the STG, as follows:

For simplicity, assume that the STG is computed as a number between 0 and 100 (0 means no trust, 100 means full trust). STG can be formatted in other ways, for example 1-5 stars.

By this example, STG is computed every time an option is displayed to a consumer. Optimization techniques can be used to cache this information, or prevent re-computing in case no data used in the computation was changed since the previous computation, all as is generally known per se.

By this example, the factors that go into the computation of the STG are:
2. The system's trust rank of the seller. The system maintains a trust rank for each seller based on the contractual agreement with the seller, money deposited by the seller to the system which is reserved to dispute resolution, and a rank entered by the system's staff that could be based on various ranking techniques (e.g. credit scoring, or background checks on the seller). Define this variable as SYSTEM_TRUST_RANK. This trust rank is entered manually and is designed to answer the questions “how respectable and trustworthy is this seller”.
3. Seller performance rank. This is a dynamically computed rank based on historic performance of the specific seller, for example how many options did this seller sell recently, or how many times did buyers complain about this seller and the complaints were found to be valid. This variable is computed for each seller periodically and stored in the systems database. Define this variable as SELLER_PERFORMANCE_RANK. The computation of this rank is explained later in this document.
4. Seller's exposure: How many options and what is the total price for all options that were issued by this seller and are still valid (not expired or exercised).
5. The price of the current option. Define this variable as OPTION_PRICE.
6. The option terms fields. For example OPTION_EXPIRATION_DATE.
7. Current pending options by this seller. These variables capture the current number of options that this seller has on sale, the number of options sold that are still valid, and the amount of money for still valid options.

By this example, the value of the STG is calculated based on the specified variables, and compute a single number that defines the specific seller's STG for the specific option. The calculation may be configurable and can be global (for all sellers), for a group of sellers or for a specific seller. A simple example for such a program:

```
    STG = minimum (SYSTEM_TRUST_RANK,
    SELLER_PERFORMANCE_RANK)
    if (OPTION_PRICE > $10,000) then STG = STG * 0.8
    if (OPTION_EXPIRATION_DATE − now < 2 weeks) then STG =
STG * 1.1
```

In accordance with a certain embodiment, the SELLER_PERFORMANCE_RANK is computed periodically (say, triggered by the scheduler 16). It is a rank that captures the snapshot of the current activity of the seller. By this example, it is based on one or more of the following variables:
The number of options sold during the last X months (say 3 months);
The price of options sold during the last X months;
The number and price of options exercised during the last X months;
The number of times buyers complained about this seller during the last X months;
The number of times buyers' complaints about this seller were found valid during the last X months;

The invention is of course not bound by the specified example. By way of non limiting example additional parameters (such as the location of the seller, the date, etc.) may be taken into account instead or in addition to one or more of the parameters specified above.

In accordance with a certain embodiment, the following information is displayed in respect of some (or all) options that are placed for trading:
The STG value
The insurance plan and the limit on insurance
Feedback information from consumers, aggregated by time, or detailed (e.g. as displayed in sites like eBay).
Having discussed trust guarantee, it should be noted that in accordance with certain embodiments, suppliers of option underlying product may have to be aware to the event of option trading, extension, or cancellation.

In this connection, in real products, when person A purchases a book from seller S, and then sells the book to person B, the seller (S) does not need to be aware of the sell between A and B. In contrast, in certain scenarios in an options system, if a person A buys from S an option for a book, and then sells the option to person B, the seller may need to know about the transfer of ownership of the option when it occurs. Furthermore, the seller may want to be able to authorize the transfer of ownership before it occurs.

As an example of the specified situation, consider a hotel that sells options of hotel rooms. The hotel needs to know when the option is sold from one owner to another, so that all reservation information in the hotel's system is up to date, so that when the most recent option owner will arrive at the hotel, the hotel will have a room ready with the correct name and room preferences.

Furthermore, the hotel may need to be able to authorize each option ownership transfer according to hotel rules and regulations. For example, the hotel may have limits on the number of people in the room, and may need to verify that the new option owner requirements fit within the limits.

In accordance with a certain embodiment, two message types can optionally be sent (using Supplier Links 19 or Notification Dispatcher 15) during one or more of the following actions: option transfer of ownership, option extension, cancellation, or any other process that can change the state of an option:

In accordance with a certain embodiment, the following message is defmed Option Provider Authorization: The system sends the seller the details of the option, and the details of the requested change, before the change is executed.

The seller can response with an authorize response, a reject response, or a request-more-information response. The “request-more-information” starts a process of interaction between the option provider and the option owner. The interaction ends when the seller sends a message of “authorize” or “reject” to the original Option Provider Authorization message.

The message is sent automatically from the options system (through module 19) when configured to send it (by seller, by product type, by dates, and by other configurable parameters. Thus, in accordance with a certain embodiment, sending the message does not happen for every product and for every provider. Based on configuration parameters, the system can determine, for instance, if a given message should be sent, how, and the destination address. The seller can automatically process the message, or can have the message delivered as a manual form message (e.g. e-mail, posted on a bulletin board or fax).

Note that the invention is not bound by the specified messages and/or by the sequence of operations discussed with reference to the specified message.

In accordance with a certain embodiment, the following message is defined Option Provider Change Message: The system sends the seller the details of the option, and the details of the executed change, after the change is executed. In other words, this message serves for reporting only and does not allow the recipient to effect the action (e.g. sell or cancel the option). The seller does not need to respond to such a message.

Thus, by this embodiment, the message is sent automatically from the options system (say through module 19), when configured to send it (for instance: by seller, by product type, by dates, and by other configurable parameters, as explained above). The seller can have a computer program that automatically processes the message, or can have the message delivered as a manual form message (e.g. e-mail, posted on a bulletin board or fax).

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In accordance with a certain embodiment, having bought an option, the owner may opt to extend the expiration time of the option. Within the option terms (discussed earlier), the seller can state if the option may be extended, the duration of each possible extension (e.g. extend by 3 days), the maximal number of extensions and the price of each extension. The option owner. may, at any time, request to extend the option (through web site 12), as long as the following conditions are met:
The option terms permit the extension
The option has not been expired
The maximal number of extensions (as stated in the option terms) has not been reached
The extension price is paid

If the extension is allowed, the system charges the owner (using Money Validator and Charger 100), credits the provider, sends notification to the provider (through Notification Dispatcher 15 or Supplier Links 19), and stores information about the extension in the database 14.

The present invention has been described with a certain degree of particularity, but those versed in the art will readily appreciate that various alterations and modifications may be carried out, without departing from the scope of the following Claims:

1. A method for trading non financial options in a virtual marketplace, comprising:
(a) an option seller provides for trading an option in respect of product or service; the option is associated with at least option price and option terms including option expiration date;
(b) an option buyer provides at least a buying price;
(c) calculating option trading, including transferring option ownership to the buyer if at least the following conditions are met:
i) verifying at least the seller, the buyer and the option,
ii) determining that if the option price matches said buying price;
iii) charging the buyer with an option price.

2. The method according to claim 1, wherein said buying price matches the option price if both prices are equal.

3. The method according to claim 1, wherein said buying price matches the option price if both prices are not necessarily equal.

4. The method according to claim 3, wherein said determining if option prices match includes applying an auction technique.

5. The method according to claim 3, wherein said determining if option prices match includes applying a reverse auction technique.

6. The method according to claim 1, wherein said providing an option for trading including: automatically generating at least one of (i) the option price and (ii) part or all of option terms, according to automatic generating rules.

7. The method according to claim 1, further comprising canceling the option for trade by an option owner.

8. The method according to claim 1, further comprising automatically canceling the option for trade in the case of option expiration event.

9. The method according to claim 1, further comprising exercising the option.

10. The method according to claim 1, wherein said virtual marketplace is implemented in the Web.

11. The method according to claim 1, further comprising, providing users feedback that pertains to the option for trade.

12. The method according to claim 1, wherein said virtual marketplace is un-regulated.

13. The method according to claim 1, wherein said verifying the seller, the buyer and the option includes;
(a) verifying identity of buyer and seller
(b) verifying that seller owns the option
(c) verifying that option is valid for transfer
(d) verifying that the sold option details match stored option details

14. The method according to claim 1, further comprising: calculating trust guarantee associated with said option.

15. The method according to claim 14, wherein said trust guarantee is calculated based on at least one of the following:
trust level of a specific seller;
price of the option;
historic data of sales by the seller.

16. The method according to claim 15, wherein said trust level of a specific seller is calculated based on at least one of the following::
agreement between system and seller;
insurance plan of seller, type and amount limit;
historic sales data of the seller.

17. A method for trading options in a virtual marketplace, comprising:
(a) an option seller providing an option for trading; the option is associated with at least option price and option terms including option expiration date;
(b) calculating trust guarantee associated with said option.

18. The method according to claim 17, wherein said trust guarantee is calculated based on at least one of the following:
trust level of a specific seller;
price of the option;
historic data of sales by the seller;
feedback of previous buyers from this seller.

19. The method according to claim 18, wherein said trust level of a specific seller is calculated based on at least one of the following::
agreement between system and seller;
insurance plan of seller, type and amount limit;
historic sales data of the seller: amount of disputed and insurance claims;
number and volume of sales that did not have dispute.

20. A method for trading options in a virtual marketplace, comprising:
(a) an option seller providing a product or service for sale;
(b) automatically generating an option for trading in respect of said product or service; the option is associated with at least option price and option terms including option expiration date.

21. The method according to claim 20, wherein said option is generated based on at least one of said parameters
current date;
product price;
inventory level;
product type or category;
product manufacturer;
product date;
product duration;
product additional attributes.

22. A method for trading non financial options in a virtual marketplace, comprising:
(a) a seller providing a product or service for sale;
(b) providing an option associated with the product or service for trading;
(c) trading the option and notifying the seller of the product that the associated option was traded.

23. The method according to claim 22, wherein said c) further comprising: notifying the seller on the option trading transaction and performing the trading after receiving approval from the seller.

24. The method according to claim 1, wherein said trading is an initial trading.

25. The method according to claim 1, wherein said trading being a subsequent trading.

26. The method according to claim 1, further comprising extending the option.

27. A program storage device readable by machine, tangibly embodying a program of instructions executable by the machine to perform method steps for trading non financial options in a virtual marketplace, comprising:
(a) providing for trading an option in respect of product or service; the option is associated with at least option price and option terms including option expiration date;
(b) providing at least a buying price;
(c) calculating option trading, including transferring option ownership to the buyer if at least the following conditions are met:
i) verifying at least the seller, the buyer and the option,
ii) determining that if the option price matches said buying price;
iii) charging the buyer with an option price.

28. A system for trading non financial options in a virtual marketplace, comprising:
(a) a unit configured to provide for trading an option in respect of product or service; the option is associated with at least option price and option terms including option expiration date;
(b) a unit configured to provide at least a buying price;
(c) a unit configured to calculate option trading, including transferring option ownership to the buyer if at least the following conditions are met:
i) verifying at least the seller, the buyer and the option,
ii) determining that if the option price matches said buying price;
iii) charging the buyer with an option price.
